(19) United States
(12) Patent Application Publication
(10) Pub. No.: US 2010/0017075 A1
(43) Pub. Date: Jan. 21, 2010

(54) Guiding Agricultural Implements

(76) Inventor: Norbert Beaujot, Regina (CA)

Correspondence Address: NIXON & VANDERHYE, PC, 901 NORTH GLEBE ROAD, 11TH FLOOR, ARLINGTON, VA, 22203, US

(21) Appl. No.: 12/224,368

(22) PCT Filed: Feb. 26, 2007
(86) PCT No.: PCT/CA2007/000291

§ 371 Date: Sep. 28, 2009

(30) Foreign Application Priority Data
Mar. 10, 2006 (CA) 2539354

(51) Int. Cl. G06F 19/00

(52) U.S. Cl. 701/50

(57) ABSTRACT

A system and method of guiding a vehicle moving an implement along crop rows in a field includes using an external guidance apparatus to receive external vehicle location signals and guide the vehicle along a desired vehicle path in response to the vehicle location signals. The position of a guide crop row location relative to the implement is also sensed and linked to the external guidance apparatus such that the external guidance apparatus is operative to laterally adjust the desired vehicle path to maintain the implement substantially on a desired implement path relative to the crop rows. The vehicle path can be directly controlled with respect to the crop rows, or row location information can be linked to the external guidance apparatus through a field guidance apparatus that is operative to shift the implement laterally relative to the vehicle.

This invention is in the field of implements such as are used in agriculture, and in particular system for guiding such implements.

### BACKGROUND

Guidance systems have been developed to reduce the deviation of the actual path of travel of an agricultural implement relative to a desired path. Typically in agricultural field operations the implement will be towed by a tractor or like vehicle and the object is to cover the entire field by passing back and forth over the field with the edge of the implement located just at the edge of the last pass such that no part of the field is missed, and yet overlap is kept to a minimum. The implement may also be mounted directly on the vehicle instead of being towed, so as to be moved along the field with the vehicle. For example in self-propelled sprayers the implement comprises spray booms extending laterally from a vehicle carrying a spray tank, pump, and like operational equipment for the implement. Similarly, tillage implements are commonly mounted on a tractor by a three point hitch arrangement.

External guidance systems include receivers mounted on the vehicle receive location information from global positioning satellites or from radio transmitter towers. The system is programmed to track the location of the vehicle over time, and using this location data, a microprocessor provides a steering guide for the vehicle.

The width of the implement being used is entered into the microprocessor and the external guidance system continuously determines the location of the vehicle and the microprocessor tracks and stores the path the vehicle takes as it passes across the field. The microprocessor can thus determine a desired second path adjacent to a first pass by moving the second path over one implement width from the first pass. As the vehicle moves along the field to create the second path, the microprocessor indicates to the vehicle operator the actual location of the vehicle compared to the desired location that is on the second path. In one common system, a light bar is used. A green light in the center of the bar indicates that the vehicle is at the correct location, while yellow lights to each side indicate a variance to the left or right, and the operator steers the vehicle accordingly. Other indicators are also known.

Automatic steering systems have now been developed whereby the microprocessor is used to actually steer the vehicle as opposed to simply indicating to the operator which direction he should steer. Typically the vehicle will be steered by a steering actuator, commonly a hydraulic steering cylinder, that is extended and retracted to steer the vehicle in response to signals from the steering wheel of the vehicle. In an auto-steering system, the microprocessor sends steering signals to the steering actuator. Using the above example of the light bar indicator, when the light is green, the microprocessor steering signal would maintain the actuator in its current position. When a yellow light indicates a variance from the desired location that is on the desired path, the microprocessor steering signal extends or retracts the steering actuator to steer the vehicle toward the desired path. When the guidance system senses that the vehicle is at a location that is on the desired path, the microprocessor steering signal would again maintain the actuator in its current position.

A “nudge” function is typically included that allow the operator to nudge the desired path laterally in small increments to fine tune the relationship of one pass to the previous pass. As well, tilt correction systems are available to provide correction to maintain the desired vehicle path at the correct location for accurate implement travel when the tractor is operating on a slope.

When using au automatic steering system, an operator will typically strike out across the field in the direction desired and establishes an AB line from a starting point A to an ending point B. The microprocessor establishes this line as the direction desired and then establishes a grid of desired paths parallel to the AB line and separated by the implement width. The operator will rum at the far end of a pass and when generally aligned in the opposite direction with a desired path, the auto-steering system will be activated to assume control of the steering actuator, either automatically or by switching control from the steering wheel to the microprocessor.

In addition to such external guidance systems, field guidance systems are also known that guide an implement in relation to crop rows, such as in U.S. Pat. No. 5,181,572 to Andersen et al. The Andersen apparatus is designed for use in row crops, where the rows of crop are planted fairly wide apart, typically 24 to 36 inches and where field operations such as cultivation are carried on in the standing crop. Such row crop field guidance systems are required in order to guide the ground engaging tools of an implement between the rows of growing crop in order to avoid damaging the crop. Such crop rows may be planted using an external guidance system, however once the plants are growing in rows, it is necessary to guide subsequent field implements between the rows to avoid damaging the plants.

Another field guidance system is disclosed in U.S. Pat. No. 6,553,925 to the present inventor Beaujot which guides a seeding implement such that the furrow openers thereof pass between the standing stubble rows of a previous crop in order to avoid disturbing the standing stubble rows and thereby reduce plugging the seeder with crop residue from the previous crop. The system of Beaujot includes a row location sensor operative to detect the standing stubble rows of a solid seeded crop, where row spacing is typically 6 to 12 inches, and a shifting mechanism operative to shift the seeder right or left relative to the towing vehicle as required to keep the furrow openers traveling on the preferred path between the rows of standing stubble.

For best operation of the Beaujot system, it is necessary to drive the vehicle so that the shifting mechanism is about in the middle of its range of lateral motion such that the seeder can readily shift either direction if required by a deviation from the desired path, either because the vehicle deviates or the standing stubble rows deviate from the existing path. Shirting the seeder right or left can also cause the seeder to skew somewhat as the towing point moves right or left of the centerline of the seeder. The Beaujot disclosure also discloses a seeder position indicator to facilitate the operator driving the vehicle to maintain the shifting mechanism in the desired central location.

The row location sensor typically can be a drag that follows between a pair of standing stubble rows, or a furrow sensor that senses the ridge of soil that is defined by the furrow into which the previous row of crop was planted. The shifting mechanism typically has a lateral range of movement about equal to the spacing between standing stubble rows, such that when moved to the end of its range of motion the mechanism will be stopped from moving further. If the implement path continues to deviate with respect to the standing stubble rows, (the sensor will be dragged laterally and begin to sense an adjacent furrow or pair of standing stubble rows, and control the shifting mechanism relative to the newly sensed row.

With the system of Beaujot, the operator must also ensure that a proper relationship is maintained relative to a previous pass of the seeder in order to avoid excessive overlap or misses between passes. Standing stubble rows are seldom perfectly aligned, such that in order to maintain the proper relationship to the previous pass the operator may have to drive to the left or right in order to move the sensor to an adjacent furrow or pair of standing stubble rows, and then steer the vehicle to maintain the shifting mechanism in about the middle of its range of lateral motion with respect to the new guide row.

An external guidance system using satellite or radio transmission location signals can be used in conjunction with the system of Beaujot, however when using an automatic steering system controlled by the location signals, the shifting mechanism is often not in the middle of its range because the vehicle path is dictated by the external location signal without regard to the position of the shifting mechanism within its range of lateral motion. Thus the shifting mechanism can be located at one end of its range of motion and the furrow openers can be traveling a path that coincides with the standing stubble rows for some distance, effectively neutralizing the field guidance system.

### SUMMARY OF THE INVENTION

It is on object of the present invention to provide a guidance system and method for implements that overcomes problems in the prior art.

The invention provides, in one embodiment, a guidance system for a vehicle moving an implement along crop rows in a field. The system comprises an external guidance apparatus operative to receive external vehicle location signals and guide the vehicle along a desired vehicle path in response to the vehicle location signals, and a row sensor operative to sense a position of a guide crop row location relative to the implement. The external guidance apparatus is linked to the row sensor and is operative to laterally adjust the desired vehicle path to maintain the implement substantially on a desired implement path relative to the crop rows.

In a second embodiment the invention provides a guidance system for a vehicle moving an implement along a field comprising a plurality of substantially parallel and equally spaced crop rows extending up from a surface of the field. The system comprises an external guidance apparatus operative to receive external vehicle location signals and guide the vehicle along a desired vehicle path in response to the vehicle location signals, and a field guidance apparatus operative in receive row location signals from a row location sensor indicating a position of a guide crop row location relative to the implement and operative to shift the implement laterally with respect to the vehicle to guide the implement along a desired implement path relative to the guide crop row location in response to the row location signals. The external guidance apparatus is operative to laterally adjust the desired vehicle path in response to shift position signals received from the field guidance apparatus.

In a third embodiment the invention provides a method of guiding a vehicle moving an implement along crop rows in a field. The method comprises, with an external guidance apparatus, receiving external vehicle location signals and guiding the vehicle along a desired vehicle path in response to the vehicle location signals and sensing a position of a guide crop row location relative to the implement. The position of the guide crop row location relative to the implement is linked to the external guidance apparatus such that the external guidance apparatus is operative to laterally adjust the desired vehicle path to maintain the implement substantially on a desired implement path relative to the crop rows.

Thus the system and method of the invention works to guide the implement with respect to crop rows, and at the same time with respect to a previous vehicle path. Where the crop rows deviate excessively from the previous vehicle path, the sensor is pulled laterally to jump a row and take guidance from an adjacent crop row.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic top view of the operation of an embodiment of the present invention;

FIG. 2 is a schematic top view of the operation of an alternative embodiment of the present invention including a field guidance apparatus linking the row location and the external guidance apparatus;

FIG. 3 is a schematic top view of a shifting mechanism for use with the embodiment of FIG. 2;

FIG. 4 is a schematic top view of the operation of the embodiment of FIG. 2 as the crop rows deviate further from the previous vehicle path and the row sensor is pulled laterally to sense a crop row location adjacent to the originally sensed crop row location;

FIG. 5 is a schematic rear view showing the operation of a tilt correction system incorporated into the external guidance apparatus;

FIG. 6 is a rear view of a tilt sensor of the tilt correction system of FIG. 5 mounted on a pivoting plate for practicing the method of the invention.

### DETAILED DESCRIPTION OF THE ILLUSTRATED EMBODIMENTS

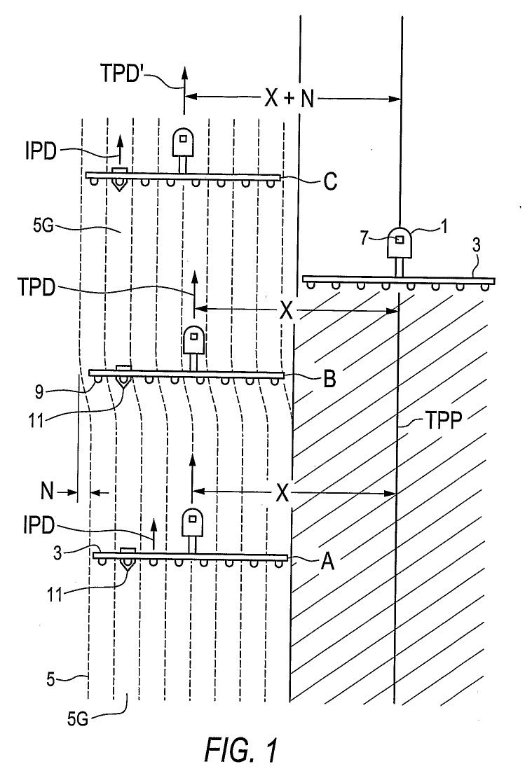

FIG. 1 schematically illustrates a method of guiding a vehicle 1 moving an implement 3 along crop rows 5 in a field. The implement 3 may be mounted on the vehicle 1 or towed behind the vehicle 1. The vehicle 1, typically a tractor in an agricultural operation, and implement 3 are shown in a first position A at the bottom of the drawing, and move up the page to position B and from there farther up to position C. The method comprises providing an external guidance apparatus 7 receiving external vehicle location signals and guiding the tractor vehicle 1 along a desired vehicle path TPD in response to the vehicle location signals. The external guidance apparatus 7 is typically a known apparatus for receiving satellite broadcast global positioning signals or location signals broadcast from lowers positioned for the purpose at locations near the field.

The desired vehicle path TPD is typically determined by storing the location of a previous vehicle path TPP in a microprocessor of (be external guidance apparatus 7, and placing the desired vehicle path TPD a lateral distance from the previous path that is equal to the width of the implement 3 being used. The external guidance apparatus 7 such as would typically be used in the method of the invention can determine the desired vehicle path TPD to within about two inches. Such external guidance apparatuses include a receiver that is located at the center of the vehicle, or sometimes the implement, in order to locate the center of the vehicle on the desired path.

The external guidance apparatus 7 will include a built in software “nudge” feature whereby the desired vehicle path TPD can be nudged to the right and left in increments of, for example 2 to 3 inches. Alternatively the receiver could be mounted on a lateral adjusting mechanism where the receiver is moved laterally by a “nudge” amount in order to move the desired vehicle path TPD closer to or farther from the previous vehicle path TPP.

The method will typically be employed in a situation where the field includes substantially parallel crop rows extending up from the field surface and separated by a substantially equal spacing distance, and where the implement path is oriented such that tools an ached to the implement travel between the crop rows. In a no-till seeding application the crop rows will be provided by standing stubble rows from the previous crop.

The method thus further comprises sensing the position of a guide crop row location 5G relative to the implement 3. Depending on the sensing mechanism used, the guide crop row location 5G can be either the space between a pair of adjacent crop rows 5, or the crop row itself. In the embodiment of FIG. 1, the sensing mechanism is a drag sensor 11 that is movably attached to the implement 3 and slides along the ground between a pair of crop rows 5, such that the guide crop row location 5G is the space between the rows 5. When the sensor 11 is centered, as illustrated at position A, the tools 9 are centered between the crop rows 5 on the desired implement path IPD. As the implement 3 and tools 9 move laterally, the sensor 11 is maintained between the crop rows 5 by contact with the crop rows 5, and therefore moves laterally with respect to the implement 3 and communicates the relative movement of the implement 3 with respect to the crop rows 5 to the external guidance apparatus 7.

In any event the result is to sense the position of the implement 3 with respect to the guide crop row location 5G, and then to link the position of the guide crop row location 5G relative to the implement 3 to the external guidance apparatus 7 such that the external guidance apparatus 7 is operative to laterally adjust the desired vehicle path TPD to maintain the implement 3 substantially on a desired implement path IPD relative to the crop rows 5. In the embodiment of FIG. 1, the method is shown being used to guide tools 9 attached to the implement 3 along a path between the crop row locations 5, and the desired implement path IPD is oriented such that the tools 9 are centered between the crop rows 5. The tools 9 are laterally spaced on the implement 3 at the same spacing as that between the crop rows 5.

For example in a no-till seeding operation, the crop rows 5 are provided by standing stubble rows from a previous crop, and the implement is a seeder. The desired implement path IPD is oriented such that furrow openers of the seeder pass between standing stubble rows of the previous crop. Similarly it is contemplated that the tools 9 could be spray nozzles, discs, or cultivator shanks where it is desired to maintain the tool centered between rows of growing crop. Further it is contemplated mat the tools might be crop lifters mounted on a combine harvester header where it is desired to maintain the crop lifters centered between rows of a crop being harvested. Those skilled in the art will recognize that many different tools could be guided using the method.

In such an application then, the object is to guide the implement both with respect to the crop rows 5 and with respect to the adjacent field worked by the implement 3 when it was following the vehicle on the previous vehicle path TPP. Where the crop rows 5 and the previous vehicle path TPP stay parallel, as illustrated at position A, the vehicle 1 can proceed along the desired vehicle path TPD and, in one embodiment of the present invention, the implement 3 is maintained in substantially fixed lateral relationship to the vehicle 1, and the sensor 11 communicates the relationship of the actual implement path to the desired implement path IPD and nudges the desired vehicle path TPD laterally to locate the tools 9 on the desired implement path IPD between the crop rows 5.

In an alternate embodiment of the invention, described below, a shifting mechanism such as is known in the prior art is used to shift the implement 3 laterally with respect to the vehicle 1 to locate the tools 9 on the desired implement path IPD between the crop rows 5, and the desired vehicle path is initially determined with respect to the previous vehicle path TPP.

Once located properly, the vehicle 1 and implement 3 proceed along the desired paths TPD and IPD as illustrated at position A. Actual field conditions arise however where the crop rows 5 deviate from their parallel relationship with the previous vehicle path TPP, as shown at position B, and the sensor 11 moves laterally with respect to the implement 3, and the tools 9 move away from the desired path centered between crop rows 5. This movement is communicated from the sensor 11 directly to the external guidance apparatus 7, which nudges the desired vehicle path DPA laterally to move the tools 9 to the centered position.

Thus at position A the desired vehicle path TPD is located a distance X from the previous vehicle path TPP. At position B the desired vehicle path TPD is still located the same distance X from the previous vehicle path TPP, however it can be seen that the sensor 11 has moved laterally to the left with respect to the implement 3 and tools 9. As the vehicle and implement move past position B toward position C, the sensor 11 has moved a distance N laterally to the left with respect to the implement 3 and tools 9. This movement is communicated to the external guidance apparatus 7, which nudges the desired vehicle path TPD a corresponding distance N to the left, such that at position C the sensor 11 is again centered and the desired vehicle path TPD′ is located a distance X+N from the previous vehicle path TPP. Thus the desired vehicle path is laterally adjusted, and the vehicle 1 is guided to follow the desired vehicle path TPD to maintain the implement 3 on a desired implement path IPD relative to the guide crop row location 5G.

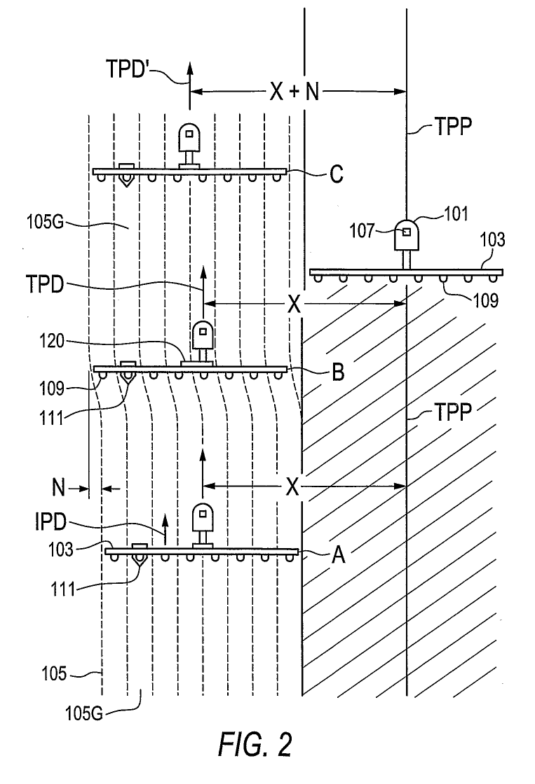

FIG. 2 schematically illustrates an alternate embodiment of the method of the invention wherein the position of the guide crop row location 105G is linked to the external guidance apparatus 107 through a field guidance apparatus 120. In this embodiment, instead of communicating directly with the external guidance apparatus as in the embodiment of FIG. 1, the row sensor 111 is operative to send row location signals, indicating the position of the guide crop row location 5G relative to the implement, to the field guidance apparatus 120, and then the field guidance apparatus is operative to shift the implement 103 laterally with respect to the vehicle 101 to guide the implement 103 along the desired implement path IDP relative to the guide crop row location 105G in response to the row location signals. The implement 103 can be either towed by the vehicle 101 or mounted on the vehicle, and the field guidance apparatus 120 can be configured as required to shift the implement 103 laterally right or left with respect to the vehicle 101 in response to the row location signals.

The external guidance apparatus 107 receives shift position signals from the field guidance apparatus 120 and laterally adjusts the desired vehicle path TPD to maintain the shift position of the field guidance apparatus 120 in a central position relative to a lateral shift range of the shifting mechanism, as described below.

The vehicle 101 and implement 103 proceed along the respective desired paths TPD and IPD as illustrated at position A of FIG. 2. When the crop rows 105 deviate from their parallel relationship with the previous vehicle path TPP, as shown between the positions A and B in FIG. 2, the sensor 111 moves laterally with respect to the implement 103, and the tools 109 begin to move away from the desired implement path IPD centered between crop rows 105. This movement is communicated from the sensor 111 to the field guidance apparatus 120 which moves the implement 103 laterally with respect to the vehicle 101 to position B, where the implement 103 is offset from the vehicle 101 and the implement 103 is on the desired implement path IPD and tools 109 are centered between the rows 105. As the vehicle and implement move past position B toward position C, the field guidance apparatus 120 shifts the implement 103 further as required to maintain the desired implement path IPD.

Thus at position A the desired vehicle path TPD is located a distance X from the previous vehicle path TPP, and the field guidance apparatus 120 is in the middle of its lateral range of movement. At position B the desired vehicle path TPD is still located the same distance X from the previous vehicle path TPP, however the sensor 111 has detected the movement of the implement 103 relative to the crop rows 105 and sent row location signals to the field guidance apparatus 120 which has shifted the implement 103 to the left relative to the vehicle 101, as illustrated, to maintain the tools 109 centered between the crop rows 105. The field guidance apparatus 120 is now in a partially offset position, and is required to move to a further offset position as the implement 103 moves from position B toward position C. Once the implement 103 has shifted with respect to the vehicle 103 by a distance equal to the nudge increment N of the external guidance apparatus 107, the external guidance apparatus 107 laterally adjusts the desired vehicle path TPD to move the vehicle laterally left to desired vehicle path TPD′, and the field guidance apparatus 120 returns to a shift position in the middle of its shift range.

Thus at position C the field guidance apparatus 120 is about centered and the desired vehicle path TPD′ is located a distance X+N from the previous vehicle path TPP. Thus the desired vehicle path is laterally adjusted to maintain the field guidance apparatus 120 in a central portion of its range of movement, where it is best situated to maintain the implement 103 on the desired implement path IPD relative to the guide crop row location 5G.

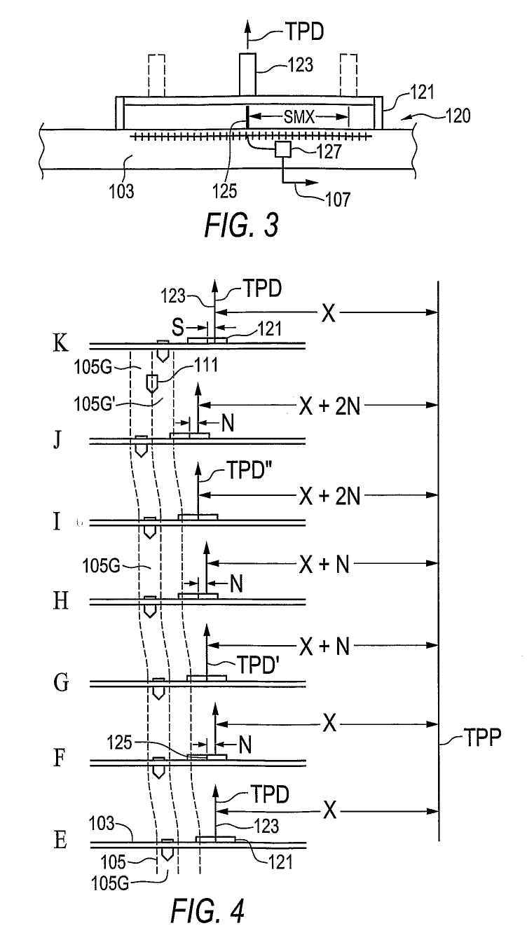

FIG. 3 schematically illustrates a shifting mechanism 121 for use in a typical field guidance apparatus 120 to shift the implement 103 laterally with respect to the vehicle drawbar 123, which for illustrative purposes is presumed to be accurately guided along the desired vehicle path TPD. The illustration shows that the shift mechanism 121 can be pushed to the right or left of a centerline 125 with respect to the drawbar 123 by a maximum shift limit distance SMX.

A shift position sensor 127 senses the offset position of the shifting mechanism 121 relative to the drawbar 123 and sends a shift position signal to the external guidance apparatus 107 on the vehicle. Typically an extendable actuator such as a hydraulic cylinder is activated by row location signals from the row sensor 111 to shift the shifting mechanism 121. It is contemplated that the shifting mechanism could alternatively be provided by a pivotal connection and actuator, or by other means that will be recognized by those skilled in the art.

FIG. 4 schematically illustrates the operation of the shifting mechanism 121 mounted on an implement 103 in a field operation with crop rows 105 extending upward from the field. The implement 103 is moving up the page from position E to position K. At position E the centerline 125 of the shifting mechanism 121 is aligned with the drawbar 123 as desired for best operation, and the external guidance apparatus is guiding the vehicle along a preferred desired vehicle path TPD selected a distance X laterally relative to a previous vehicle path TTP. Row sensor 111 is traveling along crop row location 105G.

As the crop rows deviate from the previous vehicle path TPP, the sensor 111 activates the shifting mechanism 121 which moves to the left offset position F, and a shift position signal is sent to the external guidance apparatus. When the offset distance of the centerline 125 from the drawbar 123 reaches a distance N, equal to the minimum nudge distance of the external guidance apparatus, the external guidance apparatus laterally adjusts the desired vehicle path a distance N to the left, and the vehicle and drawbar 123 begin to travel along the adjusted desired vehicle path TPD′ located a distance X+N from the previous vehicle path TPP. The shifting mechanism 121 moves back to the aligned position where the centerline 125 and drawbar 123 are aligned, as shown at position G.

As the crop rows 105 deviate further from the previous vehicle path TPP, the shifting mechanism 121 again shifts the implement 103 to the left as shown at position H, and when the shift position has shifted a distance N, the external guidance apparatus again nudges the desired vehicle path a distance N to the left. The vehicle and drawbar 123 begin to travel along the adjusted desired vehicle path TPD″ located a distance X+2N from the previous vehicle path TPP, and the shifting mechanism 121 moves back to the aligned position as shown at position I. The external guidance apparatus thus laterally adjusts the desired vehicle path TPP in increments of N in response to the shift position signals received from the shift position sensor 127. The increments N are typically significantly less than the spacing between the crop rows 105.

As the crop rows 105 deviate still further from the previous vehicle path TPP, the shifting mechanism 121 again shifts the implement 103 to the left as shown at position J, and when the shift position has shifted a distance N, the external guidance apparatus receives a shift position signal indicating the desired vehicle path should be laterally adjusted to the left again such that the desired vehicle path would then be a distance X+3N from the previous vehicle path TPP. In the illustrated operation, the maximum adjusted path is a distance of X+2N from the previous vehicle path TPP, and the external guidance apparatus is programmed such that when the shift position signal indicates path adjustment beyond the maximum, the external guidance apparatus reverts to guiding the vehicle along the preferred desired vehicle path TPD. In doing so, the sensor 111 is dragged across one of the crop rows 105 and pulled laterally a sufficient distance to sense a crop row location 105G′ that is adjacent to the guide crop row location 105G, and guidance from thereon is with reference to the adjacent crop row location 105G. In position K then, the vehicle is traveling on preferred desired vehicle path TPD a distance X laterally relative to the previous vehicle path TTP, and shifting mechanism 121 is shifted a distance S. Where the distance S equals the nudge distance N, the process above will be repeated.

In this manner the invention allows guidance with respect to the crop rows 105, but also with respect to the previous vehicle path TPP. The vehicle and implement cannot move undesirably far away from the previous vehicle path such that misses occur between the operation of one implement pass and the next, but can move laterally as required to guide tools attached to the implement between or otherwise at a desirable location with respect to the crop rows 105. Similarly where the crop rows 105 deviate towards the previous vehicle path TPP, the same operation prevents excessive overlap.

It is contemplated that the lateral distance 2N between the preferred desired path TPP and the maximum adjusted path TPP″ will typically be about equal to the shift limit distance SMX for satisfactory operation. The shift limit distance SMX is generally about one half of the spacing distance between the crop rows 105, such that, once the desired vehicle path TPP has shifted beyond half way toward the next adjacent crop row 105, the external guidance apparatus reverts back to the original preferred desired vehicle path TPP and guidance is taken from on adjacent row.

Thus a guidance system for a vehicle moving an implement along crop rows in a field in accordance with the method of the invention comprises the external guidance apparatus 7, 107 operative to receive external vehicle location signals and guide the vehicle 1, 101 along a desired vehicle path TPD in response to the vehicle location signals, and a row sensor 11, 111 operative to sense a position of a guide crop row location 5G, 105G relative to the implement 3, 103. The external guidance apparatus is linked to the row sensor and is operative to laterally adjust the desired vehicle path to maintain the implement substantially on the desired implement path relative to the crop rows.

The row sensor can send row location signals, indicating the position of the guide crop row location relative to the implement, directly to the external guidance apparatus as in the operation illustrated in FIG. 1, which can be operative to laterally adjust the desired vehicle path to maintain the implement on a desired implement path relative to the guide crop row location. Alternatively the row sensor can be linked to the external guidance apparatus through a field guidance apparatus, where the row sensor is operative to send row location signals to the field guidance apparatus, and the field guidance apparatus includes a shifting mechanism operative to shift the implement laterally with respect to the vehicle to guide the implement along a desired implement path relative to the guide crop row location, as illustrated in the operation of FIG. 2. The external guidance apparatus then maintains the implement on the desired implement path by receiving shift position signals from the field guidance apparatus and laterally adjusting the desired vehicle path to maintain the shifting mechanism in a central position relative to a lateral shift range of the shifting mechanism.

The external guidance apparatus can include an automatic steering mechanism operative to steer the vehicle on the desired vehicle path, or can include a vehicle position indicator operative to indicate to an operator the vehicle position relative to the desired vehicle path to allow the operator to steer the vehicle on the desired vehicle path. Both such systems are known in the prior art.

In order to maintain guidance from both the crap rows and the previous vehicle path, the external guidance apparatus adjusts the desired path from a preferred desired path selected relative to a previous vehicle path, laterally to a maximum adjusted path only, and then reverts back to the preferred desired vehicle path when a shift signal is received indicating a lateral adjustment in excess of the maximum. The sensor will then “jump” a row and begin guiding from a crop row location adjacent to the original guide crop row location.

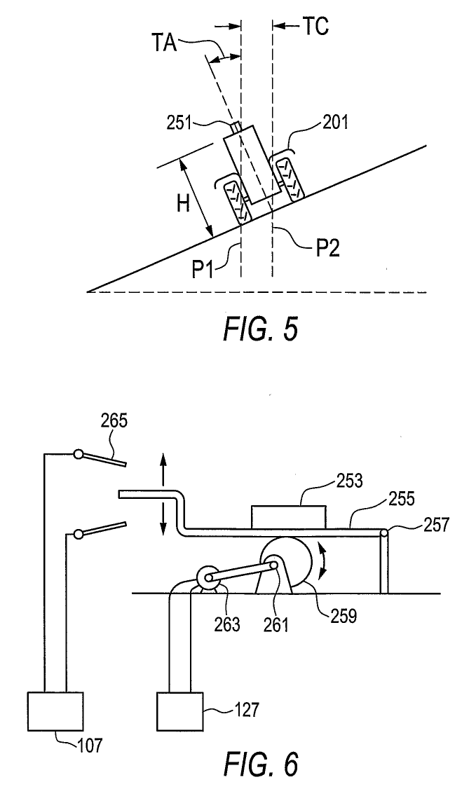

It is known in the art as well to provide a tilt correction system with a GPS or like external guidance system. Operation of such a tilt correction system is schematically illustrated in FIG. 5. When a tractor 201 is being positioned by external guidance, a position error is inherent on side slopes because the signal receiver 251, in order to clearly receive the guidance signal, is mounted on top of a cab of the tractor 201. Thus the receiver 251 is often 10 feet above the ground, and not at ground level where the agricultural activity is taking place, and where the desired vehicle path is located. The error is a direct function of the tilt angle TA and the receiver height H.

As shown in FIG. 5, the receiver 251 shows the tractor 201 to be on the desired path at position P1, however the center of the tractor 201 at ground level, and the center of any implement towed by the tractor, is actually at P2, a lateral distance off the desired path. By measuring the tilt angle TA, and with the known receiver height H, the tilt correction, system calculates the lateral distance between P1 and P2 as a tilt correction distance TC, and sends this correction to the external guidance apparatus, which makes the adjustment of the desired vehicle path TPD from P2 to P1.

As seen in FIG. 6, a tilt sensor 253 is fixed to the tractor 201 in a level position, typically in the cab of the tractor 201. When the tractor 201 is operating on level ground the tilt sensor 253 is in a neutral position. When the tractor 201 tilts laterally on un-level land, as illustrated in FIG. 5, the tilt sensor 253 detects the tilt direction and the tilt angle TA, and calculates the adjustment necessary to locate the center of the implement on the correct path.

Thus, conceptually the tilt correction system operates to automatically “nudge” the desired vehicle path TPD laterally far one side or the other in the same way that the software “nudge” feature built into the external guidance apparatus 7 nudges the desired vehicle path. Thus where available the tilt correction system can be used to guide the implement instead of the nudge feature. Instead of nudging the desired vehicle path TPD in increments, the tilt correction system more or less constantly senses the tilt angle TA and sends corrections to move the desired vehicle path TPD laterally by the tilt correction distance TC.

In order to use the tilt correction system in the method of the present invention FIG. 6 illustrates a rear view of a tilt sensor 253 mounted to sensor plate 255 that is pivotally mounted at a pivot point 257 above the tractor cab floor 258 so that the plate 255 can move up and down. The plate 255 is supported on a cam 259 that is rotated about an eccentric axis 261 by a slow rotating gear motor 263. Thus as the cam 259 rotates about the axis 261, the plate 255 moves up and down so that the sensor 253 senses a tilt laterally to the left or right and so sends a correction signal to the external guidance apparatus to adjust the desired vehicle path.

In the above description of the operation of the system of FIG. 4 using the nudge feature of the external guidance apparatus, when the offset distance of the centerline 125 from the drawbar 123 reaches a distance N, equal to the minimum nudge distance of the external guidance apparatus, the external guidance apparatus laterally adjusts the desired vehicle path a distance N to the left, and the vehicle and drawbar 123 begin to travel along the adjusted desired vehicle path TPD′ located a distance X+N from the previous vehicle path TPP. The shifting mechanism 121 moves back to the aligned position where the centerline 125 and drawbar 123 are aligned, as shown at position G.

In the alternative system using the tilt correction system instead of the nudge feature, as the offset distance of the centerline 125 from the drawbar 123 increases, the gear motor 263 rotates the cam 259 to pivot the plate 255 up or down, depending on the direction of the deviation as sensed by the shift position sensor 127. The tilt sensor thus senses that the tractor is tilting, and sends a correction signal to the external guidance apparatus to adjust the desired vehicle path to tiring the shifting mechanism back to the neutral or aligned position. The adjustment is thus more or less continuous instead of incremental as when using the nudge function. The conventional tilt correction system continues to operate as the tractor tilts as well, with the artificial tilt of the plate 255 superimposed on the actual tilt of the tractor.

With the nudge function, when a set limit is reached, such as when the desired vehicle path has deviated by a distance exceeding the maximum adjusted path of X+2N from the previous vehicle path TPP, the external guidance apparatus is programmed such that when the shift position signal indicates path adjustment beyond the maximum, the external guidance apparatus reverts to guiding the vehicle along the preferred desired vehicle path TPD. In doing so, the sensor 111 is dragged serosa one of the crop rows 105 and pulled laterally a sufficient distance to sense a crop row location 105G′ that is adjacent to the guide crop row location 105G, and guidance from thereon is with reference to the adjacent crop row location 105G.

Similarly when the sensor plate 255 reaches a maximum tilt it contacts upper or lower limit switches 265 which send limit signals to a timed relay or like device 267 which cuts off signals from the shift position sensor 127 to the gear motor 263, and resets the sensor plate 255 in the level neutral position illustrated in FIG. 6 which position is determined by a sensor of some kind, or by recording the rotation of the gear motor. The external guidance system then reverts to guiding the tractor along the preferred desired vehicle path TPD, dragging the sensor to a location where the sensor senses an adjacent crop row, in a manner substantially the same as described above where the nudge feature is used. After the timed interval for returning the sensor plate 255 to neutral, the timed relay 267 again allows signals from the shift position sensor 127 to be received by the gear motor 263 to again tilt the sensor plate 255 as before.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A guidance system for a vehicle moving an implement along crop rows in a field, the system comprising:
an external guidance apparatus operative to receive external vehicle location signals and guide the vehicle along a desired vehicle path in response to the vehicle location signals; and
a row sensor operative to sense a position of a guide crop row location relative to the implement;
wherein the external guidance apparatus is linked to the row sensor and is operative to laterally adjust the desired vehicle path to maintain the implement substantially on a desired implement path relative to the crop rows.

2. The system of claim 1 wherein the row sensor is operative to send row location signals, indicating the position of the guide crop row location relative to the implement, to the external guidance apparatus, and wherein the external guidance apparatus is operative to laterally adjust, the desired vehicle path to maintain the implement on a desired implement path relative to the guide crop row location.

3. The system of claim 2 the external guidance apparatus includes an automatic steering mechanism operative to steer the vehicle on the desired vehicle path.

4. The system of claim 2 wherein the external guidance apparatus includes a vehicle position indicator operative to indicate to an operator the vehicle position relative to the desired vehicle path to allow the operator to steer the vehicle on the desired vehicle path.

5. The system of claim 2 wherein the guide crop row location is one of a plurality of substantially parallel crop row locations separated by a spacing distance, and wherein the implement path is oriented such that tools attached to the implement travel between the crop row locations.

6. The system of claim 5 wherein the external guidance apparatus laterally adjusts the desired vehicle path in increments, and wherein the spacing distance is greater than the increments.

7. The system of claim 5 wherein the external guidance apparatus laterally adjusts the desired vehicle path in response to a tilt sensor linked to the row sensor.

8. The system of claim 1 wherein the external guidance apparatus is linked to the row sensor through a field guidance apparatus, and wherein:
the row sensor is operative to send row location signals, indicating the position of the guide crop row location relative to the implement, to the field guidance apparatus; the field guidance apparatus includes a shifting mechanism operative to shift the implement laterally with respect to the vehicle to guide the implement along a desired implement path relative to the guide crop row location in response to the row location signals:
the external guidance apparatus maintains the implement on the desired implement path by receiving shift position signals from the field guidance apparatus and laterally adjusting the desired vehicle path to maintain the shifting mechanism in a central position relative to a lateral shift range of the shifting mechanism.

9. The system of claim 8 wherein the shifting mechanism is operative to shift the implement laterally with respect to the vehicle a shift limit distance right and left of an aligned position of the shifting mechanism, and is operative to send shift position signals, indicating a position of the shifting mechanism relative to the aligned position, to the external guidance apparatus, and the external guidance apparatus is operative to laterally adjust the desired path to substantially maintain the location of the shifting mechanism in proximity to the aligned position.

10. The system of claim 9 wherein the external guidance apparatus adjusts the desired path from a preferred desired path selected relative to a previous vehicle path, laterally to a maximum adjusted path.

11. The system of claim 10 wherein, upon receipt of a shift position signal indicating the desired path should be laterally adjusted beyond the maximum adjusted path, the external guidance apparatus reverts to guiding the vehicle along the preferred desired vehicle path, such that the row sensor is pulled laterally a sufficient distance to sense a crop row location adjacent to the guide crop row location, and such that the field guidance apparatus guides the implement along a desired implement path relative to the crop row location adjacent to the guide crop row location.

12. The system of claim 11 wherein a lateral distance between the preferred desired path and the maximum adjusted path is substantially equal to the shift limit distance.

13. The system of claim 12 wherein the guide crop row location is one of a plurality of substantially parallel crop row locations separated by a spacing distance, and wherein the implement path is oriented such that tools attached to the implement travel between the crop row locations.

14. The system of claim 13 wherein a lateral distance between the preferred desired path and the maximum adjusted path is substantially equal to the shift limit distance, and wherein the shift limit distance is about one half of the spacing distance, and wherein the external guidance apparatus laterally adjusts the desired vehicle path in increments in response to the shift position signals, and wherein the spacing distance is greater than the increments.

15. The system of claim 13 wherein the external guidance apparatus laterally adjusts the desired vehicle path in response, to a tilt sensor linked to the row sensor.

16. The system of claim 1 wherein the implement is a seeder and wherein the guide crop row location is defined by at least one standing stubble row from a previous crop, and wherein the desired implement path is oriented such that furrow openers of the seeder pass between standing stubble rows of the previous crop.

17. A guidance system for a vehicle moving an implement along a field comprising a plurality of substantially parallel and equally spaced crop rows extending up from a surface of the field, the system comprising:
an external guidance apparatus operative to receive external vehicle location signals and guide the vehicle along a desired vehicle path in response to the vehicle location signals; and a field guidance apparatus operative to receive row location signals from a row location sensor indicating a position of a guide crop row location relative to the implement and operative to shift the implement laterally with respect to the vehicle to guide the implement along a desired implement path relative to the guide crop row location in response to the row location signals; wherein the external guidance apparatus is operative to laterally adjust the desired vehicle path in response to shift position signals received from the field guidance apparatus.

18. The system of claim 17 wherein the field guidance apparatus comprises a shifting mechanism operative to shift the implement laterally with respect to the vehicle a shift limit distance right and left of an aligned position of the shifting mechanism, and wherein the shift location signals correspond to a location of the shifting mechanism relative to the aligned position, and the external guidance apparatus is operative to laterally adjust the desired path to maintain the location of the shifting mechanism in proximity to the aligned position.

19. The system of claim 17 wherein the external guidance apparatus laterally adjusts the desired path from a preferred desired path selected relative to a previous vehicle path, to a maximum adjusted path, and wherein upon receipt of a shift location signal indicating the desired path should be laterally adjusted beyond the maximum adjusted path, the external guidance apparatus reverts to guiding the vehicle along the preferred desired vehicle path, and the field guidance apparatus guides the implement along a desired implement path relative to a crop row location adjacent to the guide crop row location.

20. The system of claim 17 wherein the implement is a seeder and wherein the crop rows comprise standing stubble rows from a previous crop.

21. A method of guiding a vehicle moving an implement along crop rows in a field, the method comprising: with an external guidance apparatus, receiving external vehicle location signals and guiding the vehicle along a desired vehicle path in response to the vehicle location signals; and sensing a position of a guide crop row location relative to the implement;
linking the position of the guide crop row location relative to the implement to the external guidance apparatus such that the external guidance apparatus is operative to laterally adjust the desired vehicle path to maintain the implement substantially on a desired implement path relative to the crop rows.

22. The method of claim 21 comprising laterally adjusting the desired vehicle path to maintain the implement on a desired implement path relative to the guide crop row location.

23. The method of claim 21 wherein the desired implement path is oriented such that tools attached to the implement travel between the crop row locations.

24. The method of claim 21 wherein the position of the guide crop row location is linked to the external guidance apparatus through a field guidance apparatus, and wherein:
a row sensor is operative to said row location signals, indicating the position of the guide crop row location relative to the implement, to the field guidance apparatus;
the field guidance apparatus is operative to shift the implement laterally with respect to the vehicle to guide the implement along a desired implement path relative to the guide crop row location in response to the row location signals; and the external guidance apparatus maintains the implement on the desired implement path by receiving shift position signals from the field guidance apparatus and laterally adjusting the desired vehicle path to maintain a shift position of the field guidance apparatus in a central position relative to a lateral shift range of the shifting mechanism.

25. The method of claim 24 wherein the external guidance apparatus adjusts the desired path from a preferred desired path selected relative to a previous vehicle path, laterally to a maximum adjusted path, and wherein, upon receipt of a shift position signal indicating the desired path should be laterally adjusted beyond the maximum adjusted path, the external guidance apparatus reverts to guiding the vehicle along the preferred desired vehicle path, such that the row sensor is pulled laterally a sufficient distance to sense a crop row location adjacent to the guide crop row location, and such that the field guidance apparatus guides the implement along a desired implement path relative to the crop row location adjacent to the guide crop row location.

26. The method of claim 25 wherein a lateral distance between the preferred desired path and the maximum adjusted path is substantially equal to the shift limit distance.

27. The method of claim 26 wherein the guide crop row location is one of a plurality of substantially parallel crop row locations separated by a spacing distance, and wherein the implement path is oriented such that tools attached to the implement travel between the crop row locations.

28. The method of claim 21 wherein the implement is a seeder and wherein the crop rows comprise standing stubble rows from a previous crop, and wherein the desired implement path is oriented such that furrow openers of the seeder pass between the standing stubble rows of the previous crop.
